(19) United States
(12) Patent Application Publication
(10) Pub. No.: US 2024/0078918 A1
(43) Pub. Date: Mar. 7, 2024

(54) FULFILLING A REQUEST ASSOCIATED WITH OPERATIONAL ASPECTS OF AN UNMANNED AERIAL VEHICLE MISSION

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 18/174,323

(22) Filed: Feb. 24, 2023

Related U.S. Application Data
(60) Provisional application No. 63/316,409, filed on Mar. 3, 2022.

(51) Int. Cl. G08G 5/00

(52) U.S. Cl. CPC G08G 5/0069

(57) ABSTRACT

Methods, systems, apparatuses, and computer program products for fulfilling a request associated with operational aspects of an unmanned aerial vehicle (UAV) mission are disclosed. In a particular embodiment, fulfilling a request associated with operational aspects of a UAV mission includes a fulfillment controller presenting to a first set of providers of a plurality of providers, a request for offers to perform a first set of operational aspects of a UAV mission. In this embodiment, the fulfillment controller also includes receiving from each provider of a second set of providers of the plurality of providers, an offer to perform a second set of operational aspects of the first set of operational aspects of the UAV mission. In addition, the fulfillment controller also selects from a first set of offers received from the second set of providers, a first offer to accept.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under 400 feet above ground level (AGL)) in airspace where FAA air traffic services are not provided. However, a framework that extends beyond the 400 feet AGL limit is needed. For example, unmanned aircraft that would be used by package delivery services and air taxis may need to travel at altitudes above 400 feet. Such a framework requires technology that will allow the FAA to safely regulate unmanned aircraft.

### SUMMARY

Methods, systems, apparatuses, and computer program products for fulfilling a request associated with operational aspects of an unmanned aerial vehicle (UAV) mission are disclosed. In a particular embodiment, fulfilling a request associated with operational aspects of a UAV mission includes a fulfillment controller presenting to a first set of providers of a plurality of providers, a request for offers to perform a first set of operational aspects of a UAV mission. In this embodiment, the fulfillment controller also includes receiving from each provider of a second set of providers of the plurality of providers, an offer to perform a second set of operational aspects of the first set of operational aspects of the UAV mission. In addition, the fulfillment controller also selects from a first set of offers received from the second set of providers, a first offer to accept.

By informing a plurality of providers of a need for UAV resources to perform operational aspects of a UAV mission and soliciting offers for those resources, a mission controller may be able to expand the options for fulfilling the UAV mission by outsourcing one or more operational aspects of the UAV mission to the providers. Furthermore, presenting the request to multiple providers may have the additional advantage of encouraging the providers to present more competitive offers and thus lower the costs of the UAV mission for the mission provider.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system for fulfilling a request associated with operational aspects of an unmanned aerial vehicle mission;

FIG. 2 is a block diagram illustrating another implementation of a system for fulfilling a request associated with operational aspects of an unmanned aerial vehicle mission;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 is a flowchart to illustrate an implementation of a method for fulfilling a request associated with operational aspects of an unmanned aerial vehicle mission;

FIG. 5 is a flowchart to illustrate an implementation of a method for fulfilling a request associated with operational aspects of an unmanned aerial vehicle mission;

FIG. 6 is a flowchart to illustrate an implementation of a method for fulfilling a request associated with operational aspects of an unmanned aerial vehicle mission;

FIG. 7 is a flowchart to illustrate an implementation of a method for fulfilling a request associated with operational aspects of an unmanned aerial vehicle mission;

FIG. 8 is a flowchart to illustrate an implementation of a method for fulfilling a request associated with operational aspects of an unmanned aerial vehicle mission; and

FIG. 9 is a flowchart to illustrate an implementation of a method for fulfilling a request associated with operational aspects of an unmanned aerial vehicle mission.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

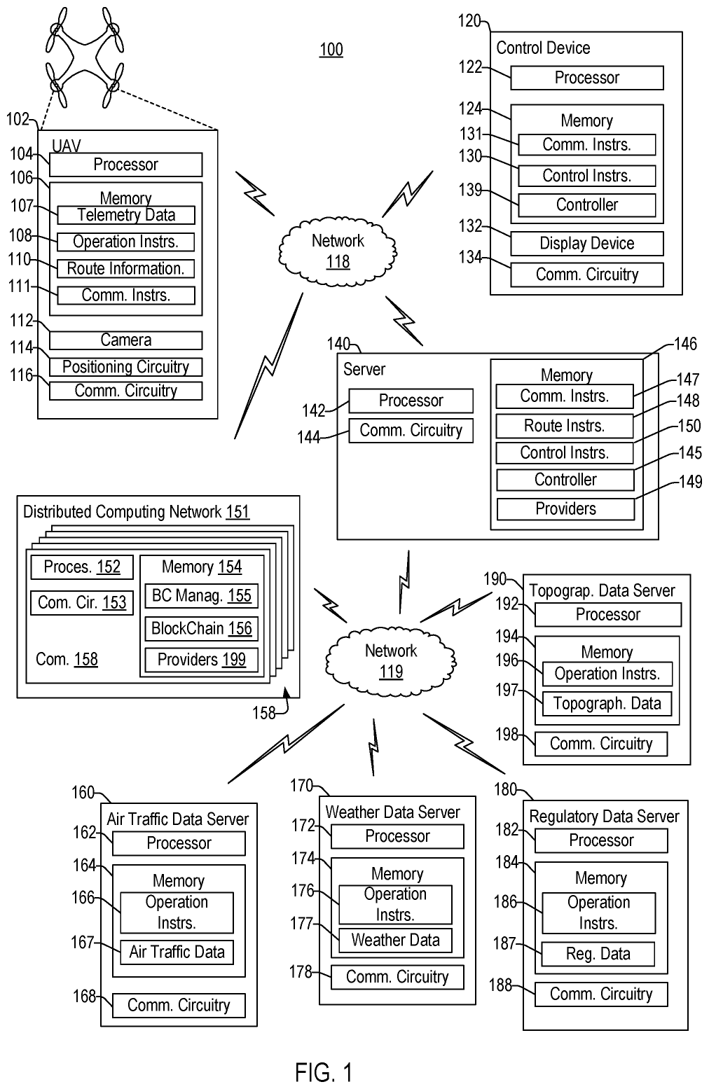

Exemplary methods, apparatuses, and computer program products for fulfilling a request associated with operational aspects of an unmanned aerial vehicle (UAV) mission in accordance with the present invention are described with reference to the accompanying drawings, beginning with FIG. 1. FIG. 1 sets forth a diagram of a system 100 configured for fulfilling a request associated with operational aspects of a UAV mission according to embodiments of the present disclosure. The system 100 of FIG. 1 includes an unmanned aerial vehicle (UAV) 102, a control device 120, a server 140, a distributed computing network 151, an air traffic data server 160, a weather data server 170, a regulatory data server 180, and a topographical data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones drone taxi, flying taxi, or pilotless helicopter carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the control device 120 or the server 140) that sent the incoming message(s). As will be explained further below, the outgoing and incoming messages may be transaction messages that include information associated with the UAV. Thus, in this implementation, communications between the UAV 102, the control device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point. The route information 110 may include a plurality of mission modes and flight paths linking the mission modes to one another.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

In the example of FIG. 1, the memory 106 of the UAV 102 also includes communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

The control device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the control device 120 and to decrypt incoming message(s) using a public key of a device (e.g., the UAV 102 or the server 140 that sent the incoming message(s). Thus, in this implementation, communication between the UAV 102, the control device 120, and the server 140 are secure and trustworthy (e.g., authenticated).

The processor 122 is configured to execute instructions from the memory 124 to perform various operations. The instructions also include control instructions 130 that include instructions or code that cause the control device 120 to generate control data to transmit to the UAV 102 to enable the control device 120 to control one or more operations of the UAV 102 during a particular time period, as further described herein.

The memory 124 of the control device 120 also includes a fulfillment controller 139 configured for multi-objective mission execution. In a particular embodiment, the fulfillment controller 139 includes computer program instructions that when executed by the processor 122 cause the processor 122 to carry out the operations of: presenting to a first set of providers of a plurality of providers, by a fulfillment controller, a request for offers to perform a first set of operational aspects of a UAV mission; receiving from each provider of a second set of providers of the plurality of providers, by the fulfillment controller, an offer to perform a second set of operational aspects of the first set of operational aspects of the UAV mission; and selecting, from a first set of offers received from the second set of providers, by the fulfillment controller, a first offer to accept.

In the example of FIG. 1, the memory 124 of the control device 120 also includes communication instructions 131 that when executed by the processor 122 cause the processor 122 to transmit to the distributed computing network 151, transaction messages that include control instructions 130 that are directed to the UAV 102. In a particular embodiment, the transaction messages are also transmitted to the UAV and the UAV takes action (e.g., adjusting flight operations), based on the information (e.g., control data) in the message.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142) is configured to encrypt outgoing message(s) using a private key associated with the server 140 and to decrypt incoming message(s) using a public key of a device (e.g., the UAV 102 or the control device 120) that sent the incoming message(s). As will be explained further below, the outgoing and incoming messages may be transaction messages that include information associated with the UAV. Thus, in this implementation, communication between the UAV 102, the control device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments. The route instructions 148 may also include instructions receiving, by a server in a UAV transportation ecosystem, disinfection area data; accessing, by the server, UAV parameters for a type of UAV; determining, by the server in dependence upon the disinfection area data and the UAV parameters, a number of UAVs needed to complete a coordinated aerial disinfection of a disinfection area within a time limit; and partitioning, by the server, the disinfection area into a plurality of partitions, wherein the number of partitions is equal to the number of UAVs. The server 140 may be configured to transmit the route information 110, including disinfection route information, to the UAV 102.

The instructions may also include control instructions 150 that include instructions or code that cause the server 140 to generate control data to transmit to the UAV 102 to enable the server 140 to control one or more operations of the UAV 102 during a particular time period, as further described herein.

The memory 146 of the server 120 also includes a fulfillment controller 145 configured for multi-objective mission execution. In a particular embodiment, the fulfillment controller 145 includes computer program instructions that when executed by the processor 142 cause the processor 142 to carry out the operations of: presenting to a first set of providers of a plurality of providers, by a fulfillment controller, a request for offers to perform a first set of operational aspects of a UAV mission; receiving from each provider of a second set of providers of the plurality of providers, by the fulfillment controller, an offer to perform a second set of operational aspects of the first set of operational aspects of the UAV mission; and selecting, from a first set of offers received from the second set of providers, by the fulfillment controller, a first offer to accept.

A provider is an entity that has resources to offer for fulfilling one or more operational aspects of a UAV mission. As the term is used in this application, a provider may refer to a human user or to a set of computer program instructions that are configured to manage UAV resources. In the example of FIG. 1, the memory 146 of the server 120 includes a plurality 149 of providers, each having computer program instructions that when executed by the processor 142 cause the processor 142 to manage UAV resources of the provider. Examples of UAV resources include but are not limited to UAVs, pilots, hardware, software modules, and UAV services. Managing UAV resources may include transmitting offers; scheduling resources; and accepting payment. The provider may manage the resources autonomously according to program functions, rules, preferences, priorities, and input from a user. Alternatively, the provider may manage the resources by presenting options to a user and receiving input from the user.

In the example of FIG. 1, the UAV 102, the control device 120, and the server 140, each include a mission controller (113, 139, 145). However, readers of skill in the art will realize that the mission controller may be included in any combination of the UAV 102, the control device 120, and the server 140. For example, in a particular embodiment, the mission controller is only included in the UAV 102. As another example, the mission controller may only be included in the control device 120.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers 157. An example computer 158 of the plurality of computers 157 is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152) is configured to encrypt outgoing message(s) using a private key associated with the computer 158 and to decrypt incoming message(s) using a public key of a device (e.g., the UAV 102, the control device 120, or the server 140) that sent the incoming message(s). As will be explained further below, the outgoing and incoming messages may be transaction messages that include information associated with the UAV. Thus, in this implementation, communication between the UAV 102, the control device 120, the server 140, and the distributed computing network 151 are secure and trustworthy (e.g., authenticated).

The processor 145 is configured to execute instructions from the memory 154 to perform various operations. The memory 154 includes a blockchain manager 155 that includes computer program instructions for operating an UAV. Specifically, the blockchain manager 155 includes computer program instructions that when executed by the processor 152 cause the processor 152 to receive a transaction message associated with a UAV. For example, the blockchain manager may receive transaction messages from the UAV 102, the control device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The memory 154 includes a plurality of providers 199 that each include computer program instructions for managing UAV resources associated with the provider. As explained above, a provider is an entity that has resources to offer for fulfilling one or more operational aspects of a UAV mission. In the example of FIG. 1, each of the plurality 199 of providers are computer program instructions that when executed by the processor 152 cause the processor 152 to manage UAV resources of the provider. Examples of UAV resources include but are not limited to UAVs, pilots, hardware, software modules, and UAV services. Managing UAV resources may include transmitting offers; scheduling resources; and accepting payment. The provider may manage the resources autonomously according to program functions, rules, preferences, priorities, and input from a user. Alternatively, the provider may manage the resources by presenting options to a user and receiving input from the user.

The UAV 102, the control device 120, and server 140 are communicatively coupled via a network 118. For example, the network 118 may include a satellite network or another type of network that enables wireless communication between the UAV 102, the control device 120, the server 140, and the distributed computing network 151. In an alternative implementation, the control device 120 and the server 140 communicate with the UAV 102 via separate networks (e.g., separate short range networks).

In some situations, minimal (or no) manual control of the UAV 102 may be performed, and the UAV 102 may travel from the origin to the destination without incident. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the control device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the control device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple of the devices of the system 100 in a manner that maintains security of the shared blockchain data structure as a public (i.e., available to other devices) and incorruptible (or tamper evident) ledger. Alternatively, as in FIG. 1, the blockchain 156 is stored in a distributed manner in the distributed computing network 151.

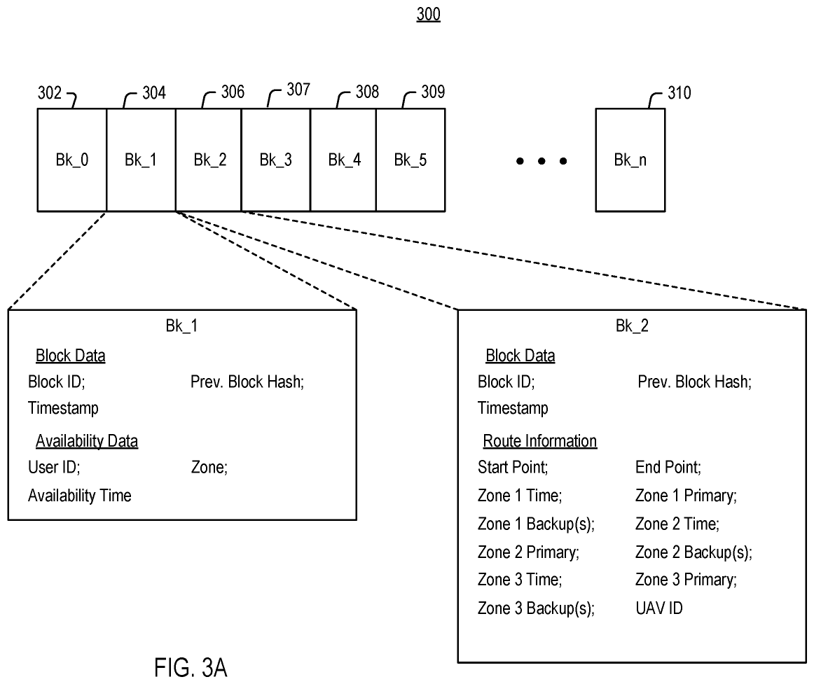

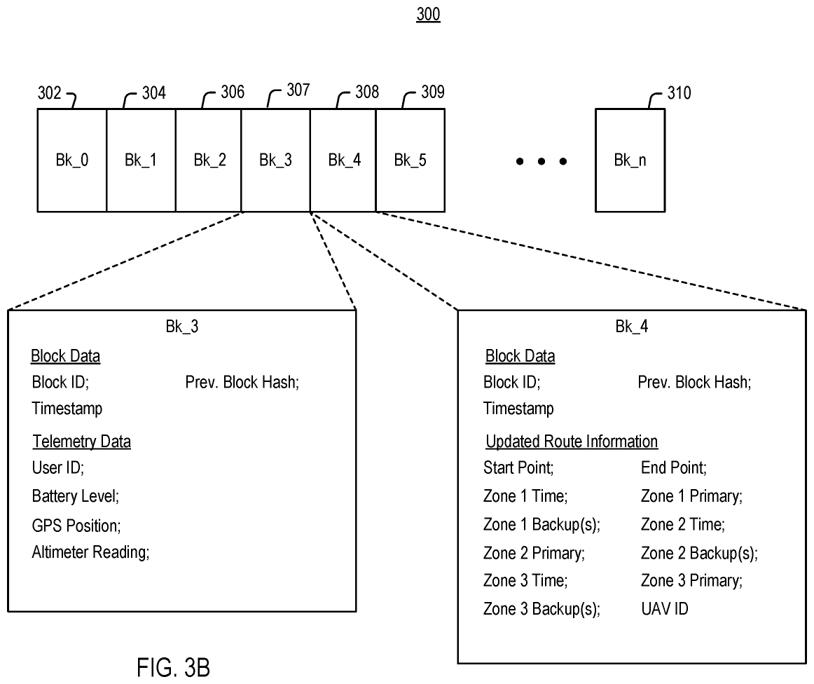

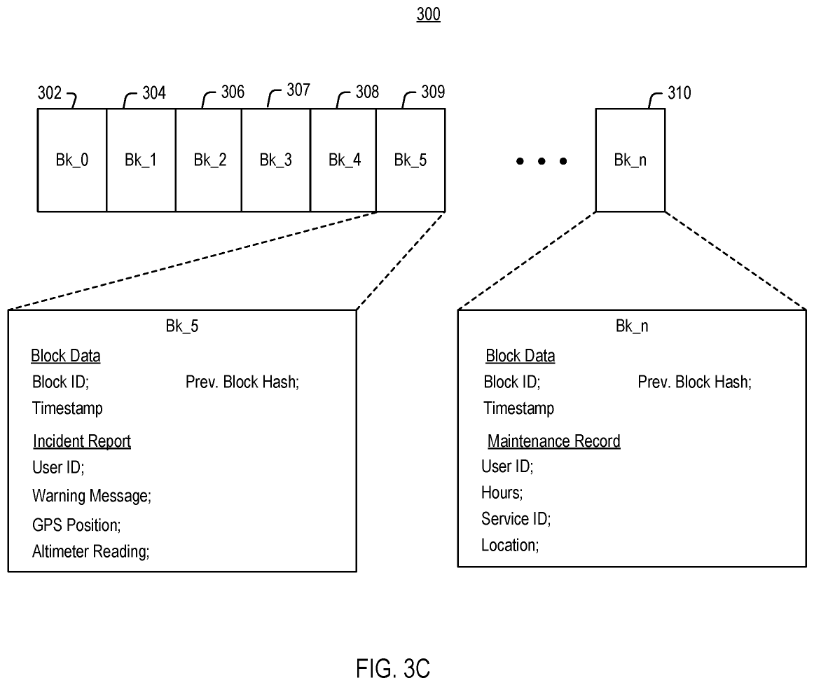

The blockchain data structure 156 may include, among other things, route information associated with the UAV 102, the telemetry data 107, the control instructions 131, and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100) to confirm the integrity of the blockchain data structure 300. For example, the block data also includes a timestamp and a previous block hash. The timestamp indicates a time that the block was created. The block ID may include or correspond to a result of a hash function (e.g., a SHA256 hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk 0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain 156.

FIG. 3B also depicts the block BK_4 308 as including updated route information having a start point, an endpoint, and a plurality of zone times and backups, along with a UAV ID. In a particular embodiment, the control device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 includes software that is configured to receive telemetry information from an airborne UAV and track the UAV's progress and status. The server 140 is also configured to transmit in-flight commands to the UAV. Operation of the control device and the server may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 101 or through direct communication with the server 140.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 180 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographical data server 190 may include a processor 192, memory 194, and communication circuitry 198. The memory 194 of the topographical data server 190 may include operating instructions 196 that when executed by the processor 192 cause the processor to provide the topographical data that indicates information about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub 1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

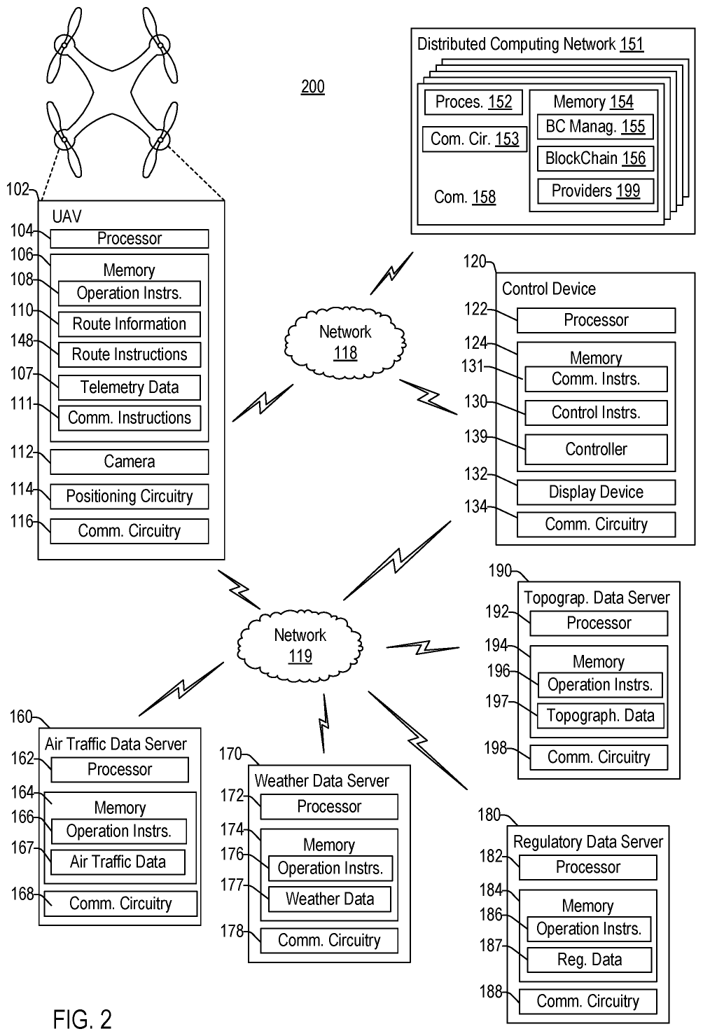

For further explanation, FIG. 2 sets forth a block diagram illustrating another implementation of a system 200 for operating a UAV. Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the control device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

A UAV, such as the UAV 102 of FIGS. 1 and 2, may be used to perform mission modes. A mission mode, as set forth herein, is defined as an intended purpose for which the UAV is being flown. In some examples, a mission mode may be strictly controlled, so that the UAV flies a particular, controlled route. For example, a waypoint mission mode follows a set of waypoints. In another example, a mission mode may include surveillance in which the UAV flies a particular pattern to observe a location. In another example, a mission mode may be loosely defined with a start time, stop time, and/or general location. For example, a mission mode may be free flight mission mode, in which there is no pattern to follow. Instead, an operator may fly the UAV during free flight using remote controls. In some examples, the mission mode may lie in between strictly controlled and loosely defined. For example, a mission mode may be a waypoint mission mode, in which the UAV should pass defined waypoints, but may be free to plot its course between the waypoints.

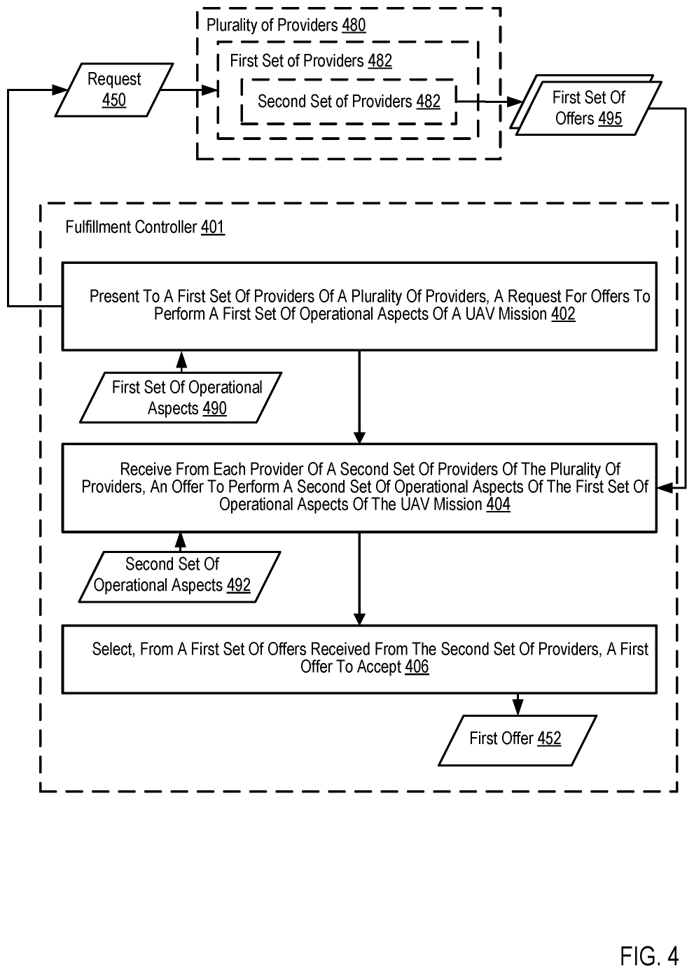

For further explanation, FIG. 4 sets forth a flow chart illustrating an exemplary method for fulfilling a request associated with operational aspects of a unmanned aerial vehicle (UAV) mission in accordance with at least one embodiment of the present disclosure. A UAV mission is the performance of a set of actions by a UAV according to one or more mission parameters. A UAV may perform a variety of actions including but not limited to flying, landing, hovering, lifting, executing software, and moving, manipulating, and controlling hardware on the UAV. As explained above, a UAV may operate in one or more mission modes.

The mission parameters may be any form of data, value, condition, or rule that can be used to explain, limit, or define some aspect of a mission. Examples of mission parameters include but are not limited to time and date constraints for starting, finishing, or completing the mission; size of a payload or package to be delivered; type of hardware to be included on the UAV; type of software to be included on the UAV; type of mission to be performed (e.g., surveillance mission, free flight mission, search mission, etc.); UAV rating (e.g., the user may require a UAV having a particular weather rating, a particular payload rating, a particular distance rating, a particular max flying height rating, a type of payload rating, and a mission type rating); and pilot rating (e.g., the user may require a pilot of a particular experience level (type of mission experience, total flying hours completed by the pilot, type of UAV experience) to fly the mission).

According to embodiments of the present invention, a UAV mission may be further defined by a plurality of operational aspects. An operational aspect of a UAV mission is a UAV resource that is required for operationally completing the UAV mission. Examples of UAV resources for performing operational aspects of a UAV mission include but are not limited to: UAVs; UAV pilots; specific software modules for the UAV to execute; specific additional hardware for the UAV; UAV maintenance services; and UAV preparation services.

In some instances, a mission controller that is organizing and planning a mission may have the UAV resources to fulfill the operational aspects of the UAV mission. For example, a mission controller may have or control a fleet of UAVs, a group of UAV pilots, and any additional hardware or software modules that the UAVs need to complete the mission. However, in some instances, a mission controller may not have the UAV resources necessary to provide all operational aspects of the UAV mission that is being planned. When the mission controller needs to source one or more operational aspects of the UAV mission, the mission controller may use a fulfillment controller 401 to receive and select offers from providers that are willing to provide the one or more operational aspects of the UAV mission.

A provider is an entity that has resources to offer for fulfilling one or more operational aspects of a UAV mission. As explained above, a provider may refer to a human user or to a set of computer program instructions that when executed by a processor cause the processor to manage UAV resources of the provider. Managing UAV resources may include transmitting offers; scheduling resources and appointments; and accepting/providing payment. In a particular embodiment, the computer program instructions of the provider may manage the resources autonomously according to program functions, rules, preferences, priorities, and input from a user. Alternatively, the provider may manage the resources by presenting options to a user and receiving input from the user.

A fulfillment controller 401 may be a module of computer program instructions that are executed on a computing device, such as a control device (e.g., the control device 120 of FIGS. 1 and 2), a server (e.g., the server 140 of FIG. 1), or some computer in a distributed computing network.

In the method of FIG. 4, the fulfillment controller 401 presents 402 to a first set 482 of providers of a plurality 480 of providers, a request 450 for offers to perform a first set 490 of operational aspects of a UAV mission. As explained above, a UAV mission may have many operational aspects and a mission controller that is planning the UAV mission may need a provider to provide some portion of the operational aspects. In the example of FIG. 4, a first set 490 of operational aspects of the UAV mission represents the operational aspects of the mission that the fulfillment controller is requesting that one or more providers provide for the UAV mission. For example, the mission controller may have selected a UAV from the mission controller's fleet of UAVs but may not have a UAV pilot selected for performing the UAV mission. In this example, the mission controller may use the fulfillment controller to present to the plurality of providers, a request for offers to perform a UAV pilot service. As another example, the mission controller may be a UAV pilot and be planning to fly the UAV mission herself, but she does not have an available UAV. In this example, the mission controller may have the fulfillment controller present to the plurality of providers, a request for offers to provide a UAV.

The fulfillment controller may present the request 450 to many providers, each of which may have different resources to provide for fulfilling the operational aspects of the UAV mission. For example, some providers may only provide UAVs; some providers may only provide pilot services; some providers may only provide additional hardware or additional software; some providers may provide maintenance or preparation services; and some providers may provide some combination of UAVs, pilots, hardware, software, and maintenance/preparation services.

In the example of FIG. 4, presenting 402 to a first set 482 of providers of a plurality 480 of providers, a request 450 for offers to perform a first set 490 of operational aspects of a UAV mission may be carried out by displaying or causing to be displayed the request to the providers via a webpage, graphical user interface, text message, email, or some other communication media or medium.

The method of FIG. 4 also includes receiving 404 from each provider of a second set 484 of providers of the plurality 480 of providers, by the fulfillment controller 401, an offer to perform a second set 492 of operational aspects of the first set 490 of operational aspects of the mission. An offer may be a data structure that indicates a particular provider is offering to provide one or more operational aspects that are listed in the first set 490 of operational aspects. In a particular embodiment, the offer may include data that indicates the provider, if selected, agree to provide the particular operational aspect. In other embodiment, the offer may include other information, such as the cost or price the provider will charge for providing the particular operational aspect; the dates or times that the provider may provide the particular operational aspect; and any other additional information, limitations, or restrictions that may be useful to the mission controller or fulfillment controller in deciding whether to accept the offer.

As explained above, the first set 490 of operational aspects includes all of the operational aspects that the fulfillment controller is attempting to fulfill. In FIG. 4, the second set 492 of operational aspects is a subset of the first set 490 of operational aspects. In a particular embodiment, the second set 492 may be directed to only one operational aspect. For example, the first set 490 of operational aspects may include a selection of a UAV and a selection of a UAV pilot, but the second set 492 of operational aspects may only include a selection of a UAV. In this example, the second set 484 of providers are a group of providers submitting offers to provide a UAV. As another example, the first set 490 of operational aspects may include a selection of a UAV and a selection of a UAV pilot, and the second set 492 of operational aspects also includes a selection of a UAV and a selection of a UAV pilot. In this example, the second set 484 of providers are a group of providers submitting offers to provide both a UAV and a UAV pilot.

As explained above, the fulfillment controller may present the request for offers in a variety of forms, such as texts, emails, graphical user interfaces, and others as will occur to those of skill in the art. Similarly, each of the providers may transmit their offers to the fulfillment controller via text, email, GUI, and others as will occur to those of skill in the art. In a particular embodiment, the fulfillment controller presents a graphical user interface on an application or webpage that presents the request. In this embodiment, each of the providers, as human users, may individually access the application or webpage to view the request and upload, select, or transmit their offers. In another embodiment, as computer program instructions, the providers may respond to the request and upload offers using an application program interface. Receiving 404 from each provider of a second set 484 of providers of the plurality 480 of providers, by the fulfillment controller 401, an offer to perform a second set 492 of operational aspects of the first set 490 of operational aspects of the mission may be carried out by receiving the offers via text, email, graphical user interface, webpage, application programing interface, or other forms of media or medium as will occur to one of skill in the art.

In addition, the method of FIG. 4 also includes selecting 406, from a first set 495 of offers received from the second set 484 of providers, by the fulfillment controller 401, a first offer 452 to accept. As part of selecting an offer from the offers, the fulfillment controller may evaluate each offer to determine if the offer complies with one or more limitations of the request. For example, a provider may have submitted an offer to provide a UAV that indicated an availability on a specific date between the hours of LOAM and 5 PM. In this example, the fulfillment controller may determine that the LOAM to 5 PM availability window is not acceptable because the request indicated that the UAV would be needed at 9 AM. A mission controller may instruct the fulfillment controller to evaluate the offers according to additional filters, limitations, or restrictions. For example, the mission controller may prefer offers that indicate availability of the resource in the morning. In this example, as part of selecting an offer, the mission controller may use the fulfillment controller to filter out all offers that do not indicate availability of the resource in the morning. As another example, the mission controller may indicate to the fulfillment controller a prioritization of price over other factors. In this example, the mission controller may instruct the fulfillment controller to select the offer with the lowest associated provider cost/price. Selecting 406, from a first set 495 of offers received from the second set 484 of providers, by the fulfillment controller 401, a first offer 452 to accept may be carried out by applying one or more selection rules and a preference selection to automatically select an offer without the input of the mission controller.

In another embodiment, the fulfillment controller may present the offers to the mission controller via a user interface and receive a selection of one of the offers from the mission controller. In this embodiment, the mission controller may instruct the fulfillment controller to apply one or more filters or restrictions to sort, reorder, eliminate, or otherwise reorganize the offers in a format to aid the mission controller in selecting an offer. For example, the fulfillment controller may present the offers as a list to the mission controller via a graphical user interface. In this example, the mission controller may instruct the fulfillment controller to sort the offers based on availability, price, provider rating, provider experience, user satisfaction with the provider, or other factors that may be useful for sorting the offers.

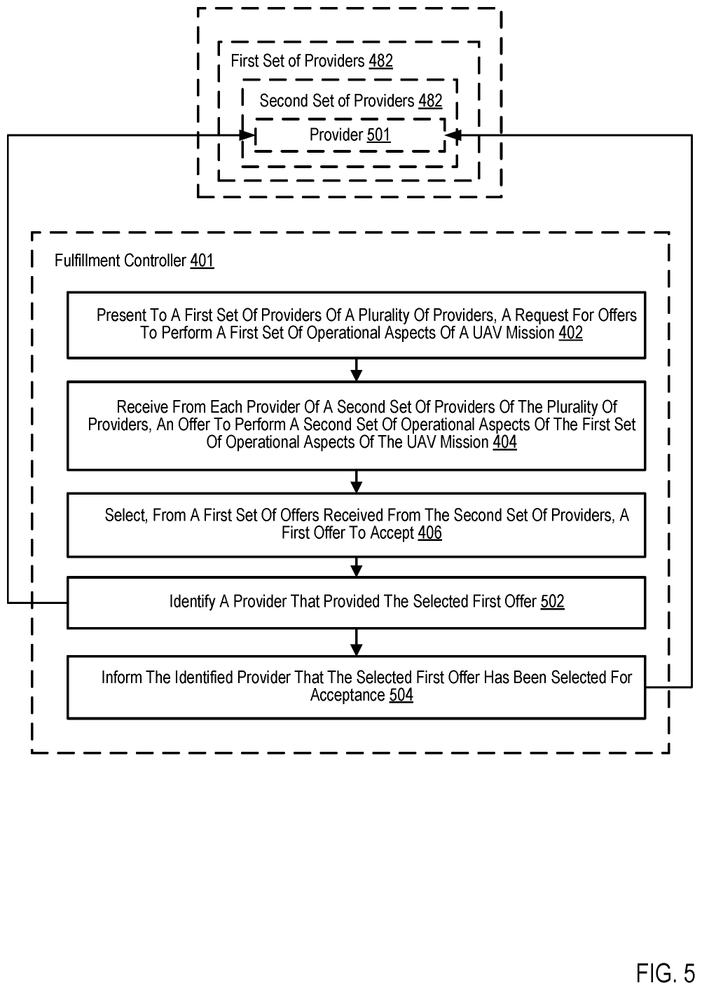

As will be explained below in FIG. 5, after selecting the first offer, the fulfillment controller may make arrangements for informing the provider that their offer has been selected and making further arrangements for securing the performance of the provider as indicated in their offer. For example, the fulfillment controller may arrangement for signing of agreements or contracts; confirming scheduling; exchanging contact information; making payment of a deposit; and other task for securing and sorting the logistics of the provider's performance.

By informing a plurality of providers of a need for resources to perform operational aspects of a UAV mission and soliciting offers for those resources, a mission controller may be able to expand the options for fulfilling the UAV mission by outsourcing one or more operational aspects of the UAV mission to the providers. Furthermore, presenting the request to multiple providers may have the additional advantage of encouraging the providers to present more competitive offers and thus lower the costs of the UAV mission for the mission provider.

For further explanation, FIG. 5 sets forth a flow chart illustrating an exemplary method for fulfilling a request associated with operational aspects of a UAV mission in accordance with at least one embodiment of the present disclosure. The method of FIG. 5 is similar to the method of FIG. 4 in that the method of FIG. 5 includes all of the limitations of the method of FIG. 4. However, the method of FIG. 5 also includes some additional methods elements the fulfillment controller performs regarding the selection of the first offer.

Specifically, the method of FIG. 5 includes the fulfillment controller 401 identifying 502, a provider 501 that provided the selected first offer 452. Identifying 502, a provider 501 that provided the selected first offer 452 may be carried out by examining information or data within the first offer for an identification of the provider associated with the offer. For example, an offer may include data that specifies a provider identification number.

In addition, the method of FIG. 5 also includes informing 504, by the fulfillment controller 401, the identified provider 501 that the selected first offer 452 has been selected for acceptance. Informing 504, by the fulfillment controller 401, the identified provider 501 that the selected first offer 452 has been selected for acceptance may be carried out by using the identification of the provider to contact the provider. For example, the identification of the provider may specify an email address; a username; a telephone number; or identification number. In this example, the fulfillment controller may use the email address or telephone number to send the provider an email or text message informing the provider that the offer has been selected for acceptance. Alternatively, the fulfillment controller may use the username or identification number to send a message through an application or lookup an email address or telephone number associated with the username or identification number.

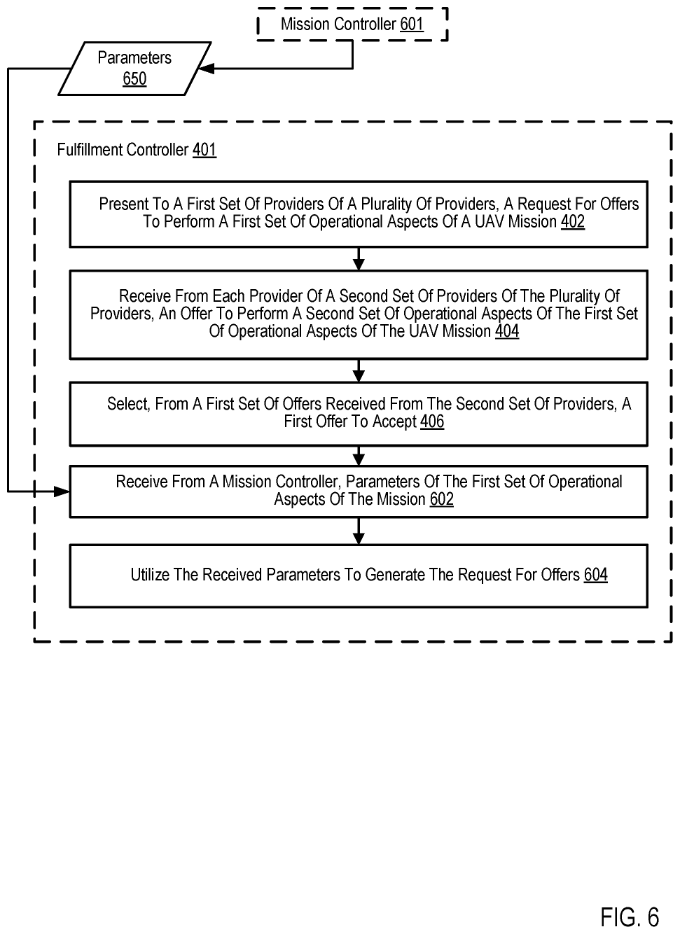

For further explanation, FIG. 6 sets forth a flow chart illustrating an exemplary method for fulfilling a request associated with operational aspects of a UAV mission in accordance with at least one embodiment of the present disclosure. The method of FIG. 6 is similar to the method of FIG. 4 in that the method of FIG. 6 includes all of the limitations of the method of FIG. 4. However, the method of FIG. 6 includes some additional method elements that the fulfillment controller performs before presenting the request to the plurality of providers.

Specifically, the method of FIG. 6 includes the fulfillment controller receiving 602 from a mission controller 601, parameters 650 of the first set 490 of operational aspects of the mission. Receiving parameters of the first set 490 from a mission controller may enable the fulfillment controller to determine the content and the format of the request to present to the plurality of providers. For example, the fulfillment controller may present a graphical user interface to the mission controller that enables the mission controller to specify the parameters of the operational aspects of the UAV mission that the mission controller wants the fulfillment controller to present in a request for offers to the plurality of providers. The parameters may specify constraints, limitations, or requirements for the operational aspects. Examples of parameters include specific date or time that the operational aspects is to be provided if the offer is accepted; budget for performance (e.g., cost not to exceed X); indication of acceptable ranges, qualifications, specifications or ratings for the operational aspects (e.g., pilot must have particular rating or qualification; UAV must have a minimum range of X; UAV must have a payload capacity of X). Receiving 602 from a mission controller 601, parameters 650 of the first set 490 of operational aspects of the mission may be carried out by receiving input from the mission controller via text, email, graphical user interface, webpage, application programming interface, or other media or medium as will occur to those of skill in the art.

In addition, the method of FIG. 6 also includes utilizing 604, by the fulfillment controller 401, the received parameters 650 to generate the request 450 for offers. Utilizing 604, by the fulfillment controller 401, the received parameters 650 to generate the request 450 for offers may be carried out by identifying the one or more operational aspects for inclusion in the request; confirming the identification of the one or more operational aspects; and populating one or more forms, texts, messages, emails, menus, or data within an application or graphical user interface to construct a request.

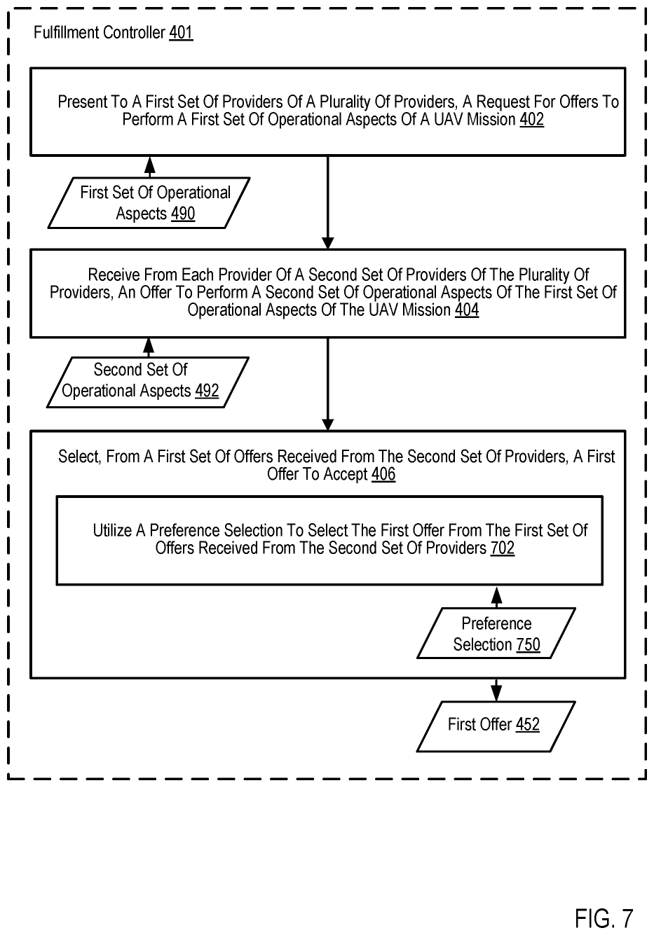

For further explanation, FIG. 7 sets forth a flow chart illustrating an exemplary method for fulfilling a request associated with operational aspects of a UAV mission in accordance with at least one embodiment of the present disclosure. The method of FIG. 7 is similar to the method of FIG. 4 in that the method of FIG. 7 includes all of the limitations of the method of FIG. 4. However, the method of FIG. 7 describes additional method elements related to the selection of a first offer.

Specifically, in the method of FIG. 7, selecting 406, from the first set 495 of offers received from the second set 484 of providers, by the fulfillment controller 401, a first offer 452 to accept includes utilizing 702 a preference selection 750 to select the first offer 452 from the first set 495 of offers received from the second set 484 of providers.

A preference selection is an identification of a priority, selection criteria, or selection rule to be applied when selecting an offer from a plurality of offers. Examples of preference selections include but are not limited to a provider price to perform the second set of operational aspects of the mission; and a provider availability to perform the second set of operational aspects of the mission.

In addition, the method of FIG. 7 includes utilizing 702 a preference selection 750 to select the first offer 452 from the first set 495 of offers received from the second set 484 of providers. Utilizing 702 a preference selection 750 to select the first offer 452 from the first set 495 of offers received from the second set 484 of providers may be carried out by identifying, sorting, or organizing the offers according to the priorities or preferences of the preference selection. In a particular embodiment, the fulfillment controller automatically selects an offer in accordance with the preference selection. Alternatively, selecting the offer may include the fulfillment controller using the preference selection to eliminate offers; sort offers; and identify a “best” offer or offers to present to the mission controller for selection. In this embodiment, utilizing 702 a preference selection 750 to select the first offer 452 from the first set 495 of offers received from the second set 484 of providers may be carried out by receiving from the mission controller a selection from a list of offers that were sorted and reduced based on the preference selection.

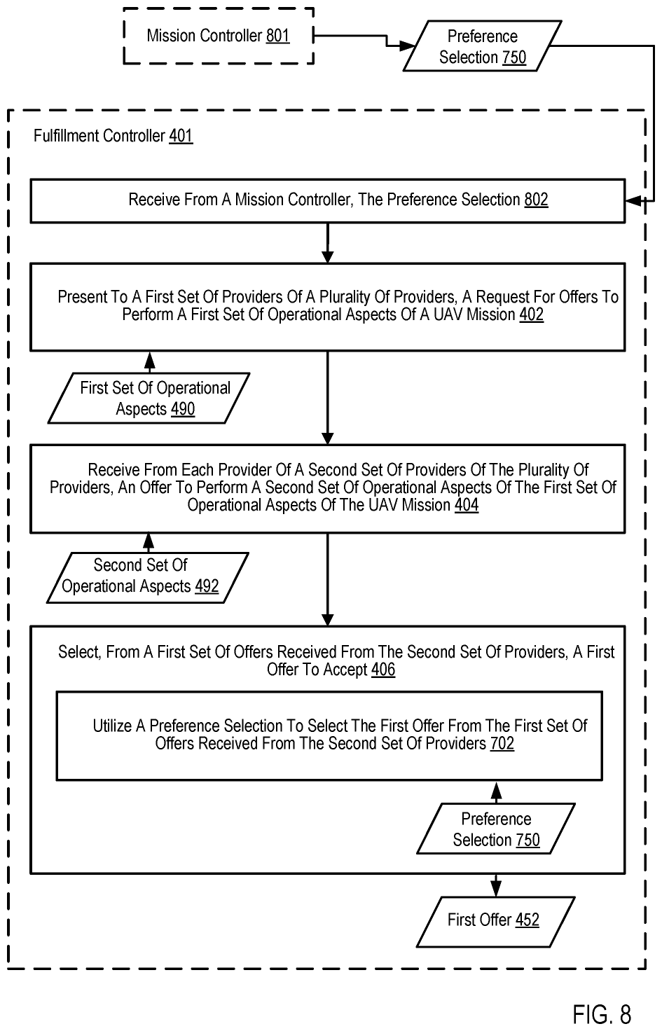

For further explanation, FIG. 8 sets forth a flow chart illustrating an exemplary method for fulfilling a request associated with operational aspects of a UAV mission in accordance with at least one embodiment of the present disclosure. The method of FIG. 8 is similar to the method of FIG. 7 in that the method of FIG. 8 includes all of the limitations of the method of FIG. 7. However, the method of FIG. 8 includes some additional methods elements the fulfillment controller performs regarding the preference selection.

Specifically, the method of FIG. 8 includes receiving 802 from a mission controller 801, by the fulfillment controller 401, the preference selection 750. A mission controller may indicate a preference selection in a variety of ways. In a particular embodiment, the fulfillment controller may have a preconfigured default for the preference selection. In a particular embodiment, the fulfillment controller may present the mission controller with options for entering or selecting a preference selection via a graphical user interface in a webpage or application. For example, the GUI may include menus options, drop down boxes, or text boxes for entering or selecting the preference selection. In a particular embodiment, the fulfillment controller may analyze written words or communications from the mission controller to infer a preference selection. For example, the fulfillment controller may receive an email from the mission controller that includes a request for “the lowest cost UAV available on a particular day.” From this phrase, the fulfillment controller may determine that the mission controller is requesting the fulfillment controller generate a request for offers for a UAV on the specified day and has a preference selection for the lowest provider cost of providing the operational aspect. Continuing with this example, the fulfillment controller may select from the offers, the offer with the lowest provider cost. Receiving 802 from a mission controller 801, by the fulfillment controller 401, the preference selection 750 may be carried out by receiving the preference selection via a graphical user interface of an application or webpage; receiving the preference selection as a menu selection, button selection, or text box input; and receiving the preference selection through written communication by the mission controller in an email or text message.

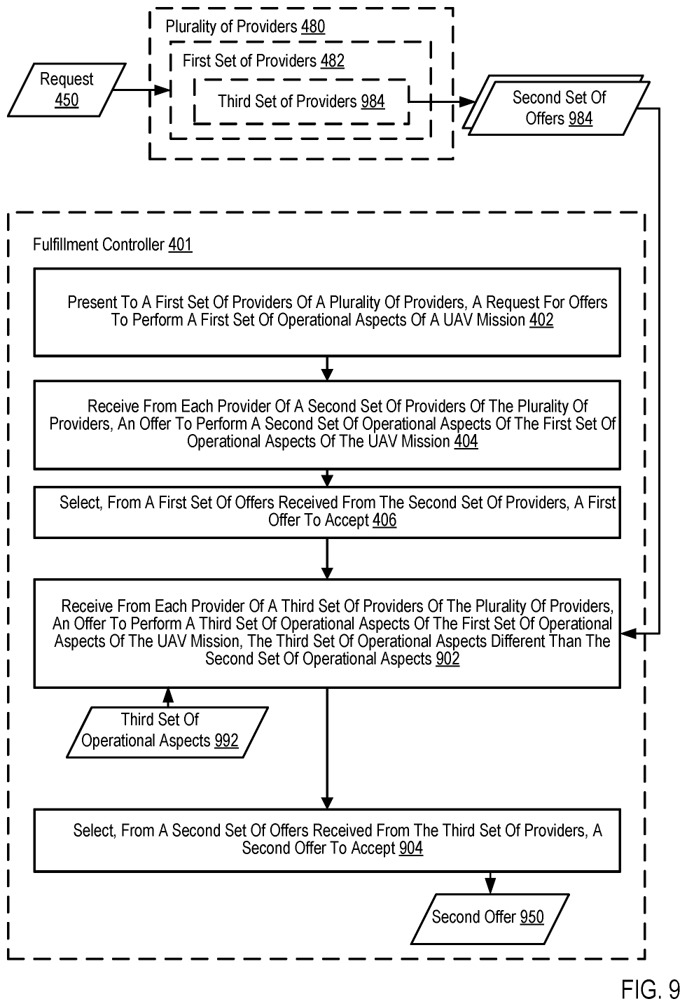

For further explanation, FIG. 9 sets forth a flow chart illustrating an exemplary method for fulfilling a request associated with operational aspects of a UAV mission in accordance with at least one embodiment of the present disclosure. The method of FIG. 9 is similar to the method of FIG. 4 in that the method of FIG. 9 includes all of the limitations of the method of FIG. 4. However, the method of FIG. 9 includes some additional methods elements that the fulfillment controller performs to select a second offer.

Specifically, the method of FIG. 9 includes receiving 902 from each provider of a third set 984 of providers of the plurality 480 of providers, by the fulfillment controller 401, an offer to perform a third set 992 of operational aspects of the first set 490 of operational aspects of the mission. As explained above, the first set 490 of operational aspects includes all operational aspects that the fulfillment controller is attempting to fulfill and the second set 492 of operational aspects is a subset of the first set 490 of operational aspects. In a particular embodiment, the second set 492 of operational aspects includes all the operational aspects of the first set 490 of operational aspects. In other embodiments, the second set 492 of operational aspects includes only some of the operational aspects of the first set 490 of operational aspects. In the example of FIG. 9, the third set 984 of operational aspects is a subset of the first set 490 of operational aspects but is different than the second set 492 of operational aspects. However, the third set 984 of providers is a subset of the first set 482 of providers but may be the same or different than the providers of the second set 484 of providers. Receiving 902 from each provider of a third set 984 of providers of the plurality 480 of providers, by the fulfillment controller 401, an offer to perform a third set 992 of operational aspects of the first set 490 of operational aspects of the mission may be carried out by receiving the offers via text, email, graphical user interface, webpage, application programming interface, or other forms of media or medium as will occur to one of skill in the art.

For example, the first set 495 of offers to perform the second set 492 of operational aspects may be limited to offers to provide a UAV and the second set 995 of offers to perform the third set 992 of operational aspects may be limited to offers to provide a UAV pilot. In this example, the fulfillment controller is able to select different offers for different operational aspects of the UAV mission.

In addition, the method of FIG. 9 also includes selecting 904, from a second set 995 of offers received from the third set 984 of providers, by the fulfillment controller 401, a second offer 950 to accept. Selecting 904, from a second set 995 of offers received from the third set 984 of providers, by the fulfillment controller 401, a second offer 950 to accept may be carried out by applying one or more selection rules and preference selection to automatically select an offer without the input of the mission controller.

In another embodiment, the fulfillment controller may present the offers to the mission controller via a user interface and receive a selection of one of the offers from the mission controller. In this embodiment, the mission controller may instruct the fulfillment controller to apply one or more filters or restrictions to sort, reorder, eliminate, or otherwise reorganize the offers in a format to aid the mission controller in selecting an offer. For example, the fulfillment controller may present the offers as a list to the mission controller via a graphical user interface. In this example, the mission controller may instruct the fulfillment controller to sort the offers based on availability, price, provider rating, provider experience, user satisfaction with the provider, or other factors that may be useful for sorting the offers.

Exemplary embodiments of the present invention are described largely in the context of a fully functional computer system for fulfilling a request associated with operational aspects of an unmanned aerial vehicle (UAV) mission. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for fulfilling a request associated with operational aspects of an unmanned aerial vehicle (UAV) mission, the method comprising:
presenting to a first set of providers of a plurality of providers, by a fulfillment controller, a request for offers to perform a first set of operational aspects of a UAV mission;
receiving from each provider of a second set of providers of the plurality of providers, by the fulfillment controller, an offer to perform a second set of operational aspects of the first set of operational aspects of the UAV mission; and
selecting, from a first set of offers received from the second set of providers, by the fulfillment controller, a first offer to accept.

2. The method of claim 1 further comprising:
identifying, by the fulfillment controller, a provider that provided the selected first offer; and
informing, by the fulfillment controller, the identified provider that the selected first offer has been selected for acceptance.

3. The method of claim 1 further comprising:
receiving from a mission controller, by the fulfillment controller, parameters of the first set of operational aspects of the mission; and
utilizing, by the fulfillment controller, the received parameters to generate the request for offers.

4. The method of claim 1, wherein selecting, from the first set of offers received from the second set of providers, by the fulfillment controller, a first offer to accept includes:
utilizing a preference selection to select the first offer from the first set of offers received from the second set of providers.

5. The method of claim 4 further comprising: receiving from a mission controller, by the fulfillment controller, the preference selection.

6. The method of claim 4, wherein the preference selection priorities at least one of: a provider price to perform the second set of operational aspects of the mission; and a provider availability to perform the second set of operational aspects of the mission.

7. The method of claim 1 further comprising:
receiving from each provider of a third set of providers of the plurality of providers, by the fulfillment controller, an offer to perform a third set of operational aspects of the first set of operational aspects of the UAV mission, the third set of operational aspects different than the second set of operational aspects; and
selecting, from a second set of offers received from the third set of providers, by the fulfillment controller, a second offer to accept.

8. The method of claim 1, wherein the first offer is for providing a UAV for the UAV mission.

9. The method of claim 1, wherein the first offer is for piloting the UAV mission.

10. The method of claim 1, wherein the first offer is for providing at least one of: additional hardware and additional software for a UAV associated with the UAV mission.

11. An apparatus for fulfilling a request associated with operational aspects of an unmanned aerial vehicle (UAV) mission, the apparatus comprising:
a processor; and
a non-transitory computer readable medium storing instructions that when executed by the processor, cause the apparatus to carry out operations including:
presenting to a first set of providers of a plurality of providers, by a fulfillment controller, a request for offers to perform a first set of operational aspects of a UAV mission;
receiving from each provider of a second set of providers of the plurality of providers, by the fulfillment controller, an offer to perform a second set of operational aspects of the first set of operational aspects of the UAV mission; and
selecting, from a first set of offers received from the second set of providers, by the fulfillment controller, a first offer to accept.

12. The apparatus of claim 11 further comprising instructions that when executed by the processor, cause the apparatus to carry out operations including:
identifying, by the fulfillment controller, a provider that provided the selected first offer; and
informing, by the fulfillment controller, the identified provider that the selected first offer has been selected for acceptance.

13. The apparatus of claim 11 further comprising instructions that when executed by the processor, cause the apparatus to carry out operations including:
receiving from a mission controller, by the fulfillment controller, parameters of the first set of operational aspects of the mission; and
utilizing, by the fulfillment controller, the received parameters to generate the request for offers.

14. The apparatus of claim 11, wherein selecting, from the first set of offers received from the second set of providers, by the fulfillment controller, a first offer to accept includes:
utilizing a preference selection to select the first offer from the first set of offers received from the second set of providers.

15. The apparatus of claim 14 further comprising instructions that when executed by the processor, cause the apparatus to carry out operations including receiving from a mission controller, by the fulfillment controller, the preference selection.

16. The apparatus of claim 14, wherein the preference selection priorities at least one of: a provider price to perform the second set of operational aspects of the mission; and a provider availability to perform the second set of operational aspects of the mission.

17. The apparatus of claim 11 further comprising instructions that when executed by the processor, cause the apparatus to carry out operations including:
receiving from each provider of a third set of providers of the plurality of providers, by the fulfillment controller, an offer to perform a third set of operational aspects of the first set of operational aspects of the UAV mission, the third set of operational aspects different than the second set of operational aspects; and
selecting, from a second set of offers received from the third set of providers, by the fulfillment controller, a second offer to accept.

18. A computer program product for fulfilling a request associated with operational aspects of an unmanned aerial vehicle (UAV) mission, the computer program product disposed upon a non-transitory computer readable medium, the computer program product comprising computer program instructions that, when executed, cause a computer to carry out the operations of:
presenting to a first set of providers of a plurality of providers, by a fulfillment controller, a request for offers to perform a first set of operational aspects of a UAV mission;
receiving from each provider of a second set of providers of the plurality of providers, by the fulfillment controller, an offer to perform a second set of operational aspects of the first set of operational aspects of the UAV mission; and
selecting, from a first set of offers received from the second set of providers, by the fulfillment controller, a first offer to accept.

19. The computer program product of claim 18 further comprising instructions that when executed by the computer, cause the computer to carry out operations including:
identifying, by the fulfillment controller, a provider that provided the selected first offer; and
informing, by the fulfillment controller, the identified provider that the selected first offer has been selected for acceptance.

20. The computer program product of claim 18 further comprising instructions that when executed by the computer, cause the computer to carry out operations including:
receiving from a mission controller, by the fulfillment controller, parameters of the first set of operational aspects of the mission; and
utilizing, by the fulfillment controller, the received parameters to generate the request for offers.
